(19) United States
(12) Patent Application Publication
(10) Pub. No.: US 2002/0035549 A1
(43) Pub. Date: Mar. 21, 2002

(54) Cost estimating method and apparatus for enabling global cost comparison

(76) Inventors: Yoshimasa Hagio, Anjo-city (JP); Yoshihiko Kitaya, Toyohashi-city (JP); Goushiro Ujlle, Nagoya-city (JP)

Correspondence Address: Larry S. Nixon, Esq., NIXON & VANDERHYE P.C., 8th Floor, 1100 North Glebe Rd., Arlington, VA, 22201-4714, US

(21) Appl. No.: 09/953,262

(22) Filed: Sep. 17, 2001

(30) Foreign Application Priority Data
Sep. 20, 2000 (JP) 2000-285733

(51) Int. Cl. G06F 17/00

(52) U.S. Cl. 705/400

(57) ABSTRACT

A cost estimating method and apparatus estimates a cost of an article with regard to operation bases spread out all over the world. An actual price database which includes actual prices of articles and a cost table which includes factors necessary for calculating virtual costs of articles are created for each possible region subjected to cost estimation beforehand. The method selects an article subjected to cost estimation and a region subjected to cost estimation of the article. If the article is actually traded in the selected region, the method retrieves, as an estimated cost of the article, the actual price of the article from the actual price database. If the article is not actually traded in the selected region, the method calculates, as an estimated cost of the article, the virtual cost of the article by using the factors in the cost table.

### CROSS REFERENCE TO RELATED APPLICATION

This application is based on and incorporates herein by reference Japanese Patent Application No. 2000-285733 filed on Sep. 20, 2000.

### BACKGROUND OF THE INVENTION

1. Field of the Invention

The present invention relates to a cost estimating method and apparatus for estimating the cost of an article involved in production with respect to each of operation bases spread out all over the world.

2. Related Art

Manufacturers globalize their operation bases nowadays, as globalization of the economy advances. Production costs often differ from operation base to operation base, even if the same article is produced at the operation bases in various parts of the world.

Therefore it is required to consider which operation base should supply the article to the market. Specifically, the cost of the article is estimated with respect to each of the operation bases, and then the estimated costs are compared. Based on the result of the comparison, it is considered and determined, from the point of view of costs, whether to produce and provide the article locally or to import the article from a foreign operation base to the market.

In the cost estimation, the actual purchase unit price of the article at an operation base is usually used as an estimated cost corresponding to the operation base, if the operation base actually trades the article. However, the estimated cost corresponding to an operation base cannot be obtained if the operation base does not actually trade the article yet, because a method for estimating the accurate cost of the article which is not actually traded is not provided.

Furthermore, the estimated costs are not compared globally.

That is, the estimated cost of the article that is produced and provided locally is only compared with the estimated cost of the article that is imported from one of the foreign operation bases. Based on the result of the comparison, it is determined whether to produce and provide the article locally or to import the article from the foreign operation base.

Thus, the operation base which supplies the article is not selected from the operation bases in various parts of the world in consideration of global cost competitiveness. Moreover the estimated cost of the article that is imported from the foreign operation base is converted using the in-company exchange rate with a time limit, and then it is compared with the estimated cost of the article that is produced and provided locally. Therefore, the costs are not compared in consideration of future fluctuations in exchange.

### SUMMARY OF THE INVENTION

The present invention has an object to provide a method and apparatus which estimates cost of articles such as products, parts, equipments, materials and molds, that is, all the articles involved in production with respect to each of operation bases in various parts of the world for enabling a user to readily determine, from the point of the view of costs, the operation base which supplies an article.

A cost estimating method according to the present invention selects an article subjected to cost estimation and a plurality of regions subjected to the cost estimation of said article. The method retrieves, as estimated costs of the article corresponding to the selected regions in which the article is actually traded, actual prices of the article from actual price databases. The actual database is created for each possible region subjected to cost estimation beforehand and includes actual prices of articles which are actually traded in the corresponding region. The method further calculates, as estimated costs of the article corresponding to the selected regions in which the article is not actually traded, virtual costs of the article by using factors in a cost table. The cost table is created for each possible region subjected to cost estimation beforehand and includes factors necessary for calculating virtual costs of articles which are not actually traded in the corresponding region. The method creates a cost comparison database by using the retrieved actual prices and the calculated virtual costs.

Thus the estimated costs of the article are provided with regard to not only regions in which the article is actually traded but also regions in which the article is not actually traded. Furthermore, the estimated costs are compared globally because all the estimated costs are provided in a form of list.

The method further performs export-import simulation so that an estimated cost including export-import cost is obtained, and calculates an equilibrium exchange rate at which an estimated cost balances the estimated cost corresponding to a specific region. The user can readily determine whether to provide the article locally or to import the article from other region based on the estimated cost including export-import cost or the equilibrium exchange rate.

The method is provided as a computer program product stored in a storage medium such as CD-ROM, and it is installed on a memory in a computer system.

### BRIEF DESCRIPTION OF THE DRAWINGS

The above and other objects, features and advantages of the present invention will become apparent from the following detailed description made with reference to the accompanying drawings. In the drawings

FIG. 1 is a block diagram of a cost estimating apparatus according to the present invention;

FIG. 2 is a diagram of formulae used for virtual cost estimation;

FIG. 3 is a diagram of a data structure of cost tables;

FIG. 4 is a flowchart of a cost estimating method according to the present invention;

FIG. 5 is a diagram of an initial data input screen for inputting data necessary for creation of a cost comparison database;

FIG. 6 is a diagram of a data output screen for displaying a list of estimated costs (actual prices);

FIG. 7 is a diagram of a data input screen for inputting data necessary for virtual cost estimation;

FIG. 8 is a diagram of a data output screen for displaying data of the cost comparison database;

FIG. 9 is a diagram of a data output screen for displaying data of the cost comparison database after exchange simulation;

FIG. 10 is a diagram of a data input screen for inputting data necessary for export-import simulation; and

FIG. 11 is a diagram of a data output screen for displaying the result of the export-import simulation.

### DETAILED DESCRIPTION OF THE PREFERRED EMBODIMENT

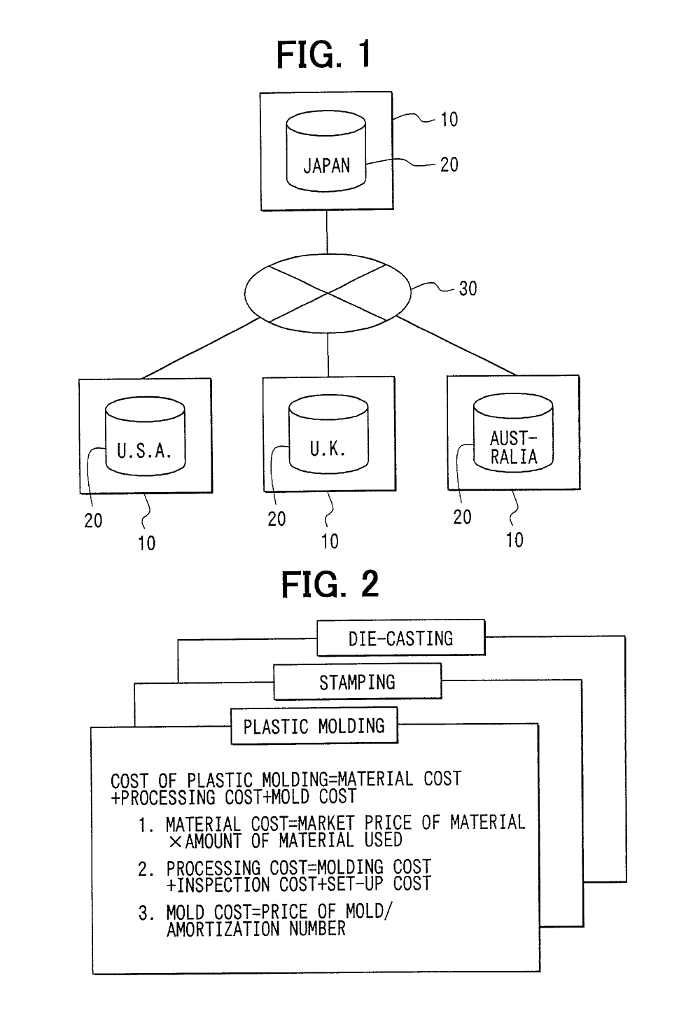

Referring to FIG. 1, a cost estimating apparatus includes computer systems 10 which are connected by a communication network 30. Each of the computer systems 10 is placed in one of operation bases in various parts of the world, such as Japan, U.S.A., U.K. and Australia. An intranet, the Internet or the like is employed as the communication network 30.

Each of the computer systems 10 includes an input unit, a display unit, and a storage unit such as a hard disk (not shown). The program (program product) of a cost estimating method which will be described later is installed from a recording medium such as CD-ROM into the storage unit.

Each of the computer systems 10 includes databases 20, and can access the databases 20 of other computer systems 10. The databases 20 includes an actual price database, regional cost tables, and export-import cost tables.

The actual price database includes actual price data (purchase prices) of articles which the operation base actually trades. The regional cost tables includes data specific to each of the operation bases. The cost estimating method creates a regional estimated cost database (cost comparison database) which is a list of estimated costs of the article corresponding to the respective operation bases by using the data in the actual price database and the regional cost tables.

Particularly, a virtual cost estimating tool, which is a part of the cost estimating method and will be described later, uses the data in the regional cost tables for estimating the virtual cost of a new article which the operation base does not actually trade. The export-import cost table includes data of expenses (e.g., packing cost, transport cost, insurance, and a custom duty) for trading the article between the operation bases. The cost estimating method simulates the import of the article into the operation base from one of other operation bases by using the data in the export-import cost tables. The actual price database and the cost tables are created and stored beforehand, and updated periodically.

The virtual cost estimating tool estimates the virtual cost of a new article which the operation base does not actually trade as follows.

The concept of cost estimation includes elements (common elements) which are common to all the operation bases and elements (operation base specific elements) which differ with operation bases. The common elements include manufacturing technologies (plastic molding, stamping, die casting and the like), the logic of cost estimation, the structure of an estimated unit cost, a method for calculating amortization expense of equipments, and the like. The operation base specific elements are regional cost information (factors of cost estimation) including market prices of materials, labor cost and the like. The virtual cost estimating tool includes a combination of the common elements and the operation base specific elements (regional cost information).

FIG. 2 shows formulae of various types of processing as examples of the common elements of cost estimation. In case of a plastic molding, its cost equals material cost plus processing cost plus mold cost as shown in FIG. 2. Further the material cost equals the market price of a material multiplied by the amount of material used (formula 1). The processing cost equals molding cost plus inspection cost plus set-up cost (formula 2). The mold cost equals the price of the mold divided by the amortization number and period (formula 3). In this way, the same formats or theories are used as the common elements at all the operation bases.

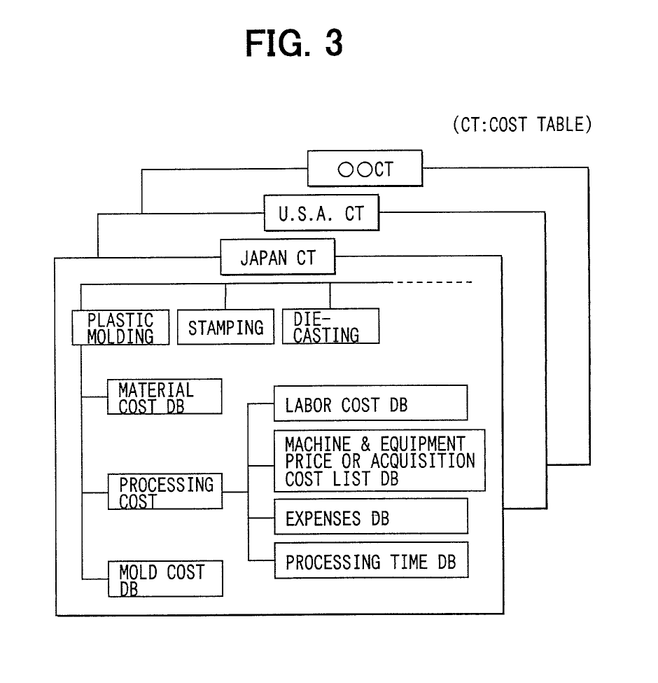

Referring to FIG. 3, at each of the operation bases, the regional cost tables are provided for each of the types of processing, and they include operation base specific data used for cost estimation. For example, at the operation base in Japan, the cost table corresponding to plastic molding includes material cost database, mold cost database and the like used for estimating the costs of plastic moldings.

The virtual cost estimating tool estimates the cost of a new article, which the operation base does not actually trade, by substituting the operation base specific data retrieved from the regional cost table in predetermined formulae as follows.

Suppose that the virtual cost of a new article (a plastic molding) should be estimated with respect to the operation bases in Japan and U.S.A., and the amount of material used for the article is 10 g.

1.1. Material Cost of the Article in Japan

Suppose that the market price of the material is 500 yen/kg. Then the material cost per article is:

500 (yen/kg)×10 (g)=5 yen.

1.2. Processing Cost of the Article in Japan

Suppose that a molding machine which has a mold clamping force of 75 t and four cavities is used and the cost of one stroke is 40 yen. Then the molding cost per article is 40 yen/4=10 yen. Suppose that the labor cost for inspection is 1 yen/s and the inspection of the article takes 10 seconds. Then the inspection cost per article is 1 (yen/s)×10 (s)=10 yen. Suppose that the set-up cost of ten thousand of the articles is 10,000 yen. Then the set-up cost per article is 10,000 (yen)/10,000=1 yen. The processing cost per article is obtained by adding up the molding cost, the inspection cost and the set-up cost as follows.

10 (yen)+10 (yen)+1 (yen)=21 yen

1.3. Mold Cost of the Article in Japan

Suppose the price of the mold is a million yen and the amortization number and period of the mold is 10,000 articles×10 years. Then the mold cost is:

1,000,000 (yen)/(10,000×10)=10 yen.

Finally, the virtual cost per article in Japan is:

5 (yen)+21 (yen)+10 (yen)=36 yen.

2.1. Material Cost of the Article in U.S.A.

Suppose that the market price of the material is 4 dollars/kg. Then the material cost per article is:

4 (dollars/kg)×10 (g)=4 cents.

2.2. Processing Cost of the Article in U.S.A.

Suppose that a molding machine which has a mold clamping force of 50 t and two cavities is used and the cost of one stroke is 20 cents. Then the molding cost per article is 20 (cents)/2=10 cents. Suppose that the labor cost for inspection is 0.5 cent/s and the inspection of the article takes 16 seconds. Then the inspection cost per article is 0.5 (cent/s)×16 (s)=8 cents. Suppose that the set-up cost of ten thousand of the articles is 200 dollars. Then the set-up cost per article is 200 (dollars)/10,000=2 cents. The processing cost is obtained by adding up the molding cost, the inspection cost and the set-up cost as follows.

10 (cents)+8 (cents)+2 (cents)=20 cents

2.3. Mold Cost of the Article in U.S.A.

Suppose the price of the mold is twenty thousand dollars and the amortization number and period of the mold is 10,000 articles×10 years. Then the mold cost per article is:

20,000 (dollars)/(10,000×10)=20 cents.

Finally, the virtual cost per article in U.S.A. is:

4 (cents)+20 (cents)+20 (cents)=44 cents.

The virtual cost of the article may be obtained without adding the mold cost, that is, the material cost plus the processing cost may be employed as the virtual cost of the article depending upon circumstances.

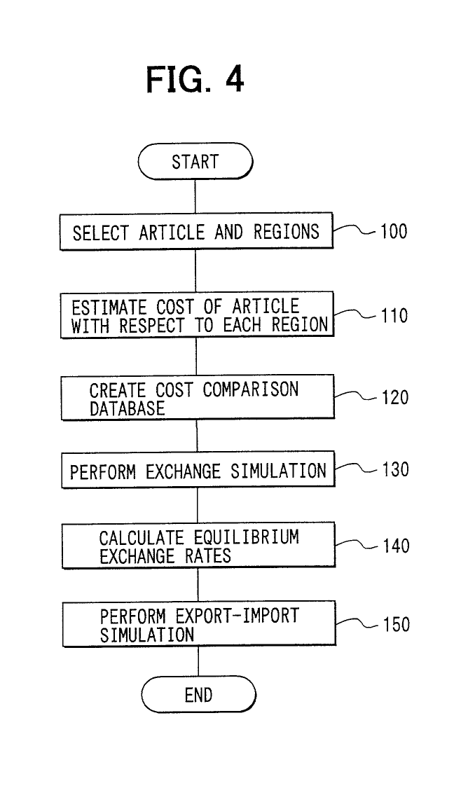

The cost estimating method including the virtual cost estimating tool performs cost estimation by executing the program stored in the storage unit of the computer system 10. Referring to FIG. 4, an article and operation bases subjected to estimation and cost comparison are selected at step 100. Suppose that the operation bases subjected to estimation and cost comparison are Japan, U.S.A., U.K. and Australia. Further suppose that the operation bases in Japan and Australia actually trade the article, and the operation bases in U.S.A. and U.K. do not actually trade the article yet.

The costs of the article are estimated with respect to the respective selected operation bases at step 110. First, step 110 is performed with respect to the operation bases in Japan and Australia, which actually trade the article, by using the actual price database. Thereafter step 110 is performed with respect to the operation bases in U.S.A. and U.K., which do not actually trade the article, by the virtual cost estimating tool using the regional cost database.

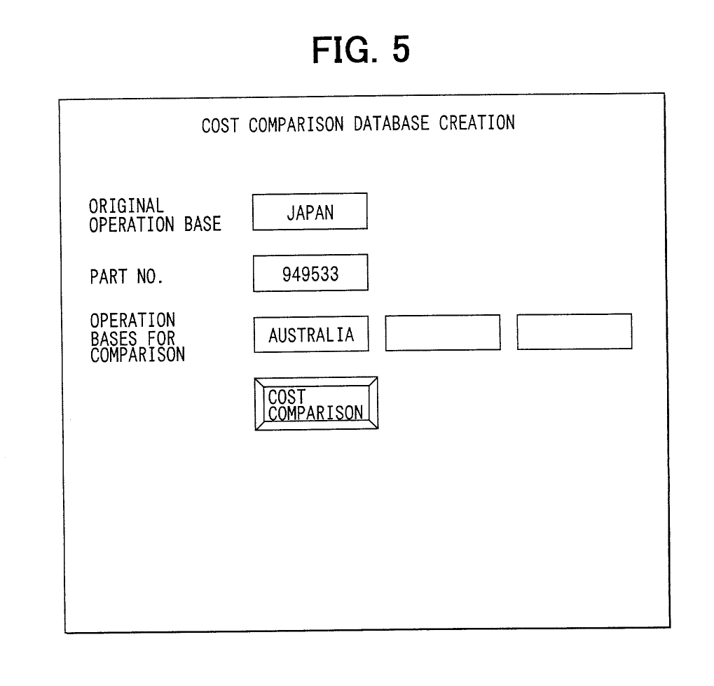

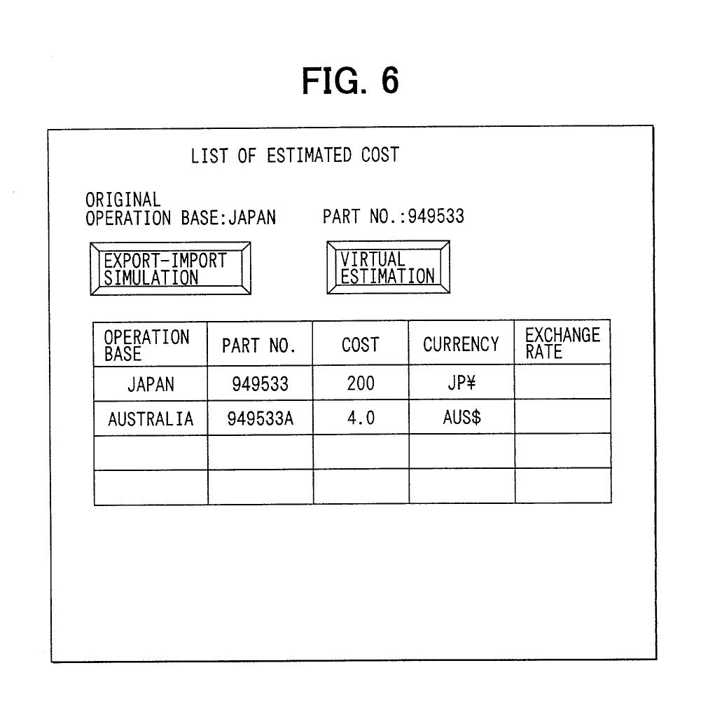

Specifically, referring to FIG. 5, a user inputs ‘Japan’ as the original operation base and the part number of the article in Japan on the initial data input screen for creating the cost comparison database. Further the user inputs ‘Australia’ as the operation base subjected to comparison. When the user selects ‘cost comparison’ button, the actual prices of the article in Japan and Australia are retrieved from the actual price database. The retrieved actual prices are displayed as the estimated costs on a data output screen as shown in FIG. 6.

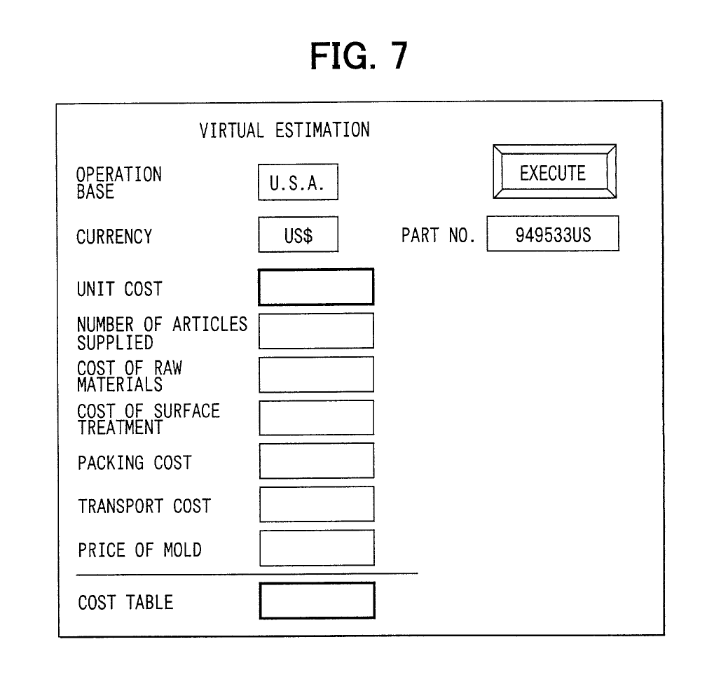

Next the user selects ‘virtual estimation’ button on the data output screen. Then the data input screen for virtual cost estimation shown in FIG. 7 appears. The user inputs the operation base which does not actually trade the article, for example U.S.A. Further the user inputs the unit cost of the article, if it is known. The inputted unit cost is used as the estimated cost of the article. If the unit cost is unknown, the user inputs items necessary for virtual cost estimation and/or a cost table to be used. The necessary items include the number of articles to be supplied, the cost of raw materials, the cost of surface treatment, the packing cost, the transport cost, the price of a mold and the like. Then the virtual cost estimating tool estimates virtual cost of the article in the above-described manner.

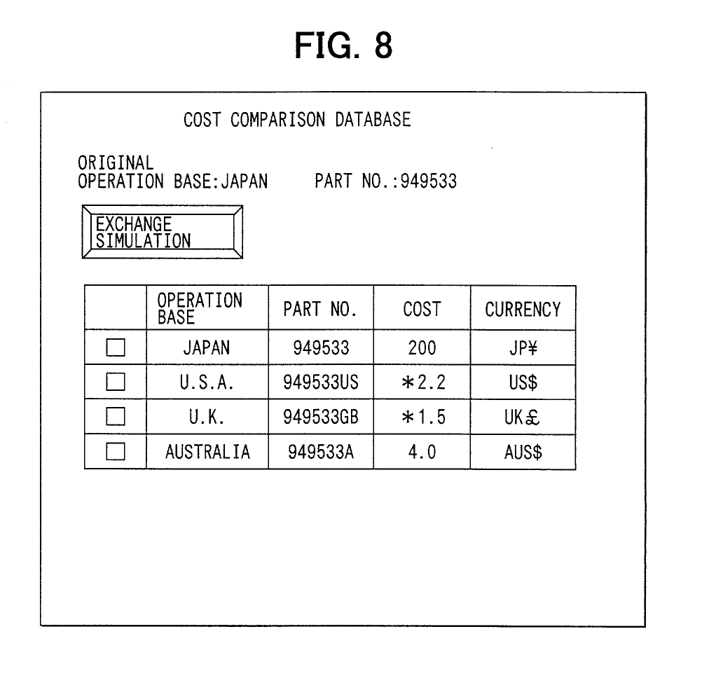

At step 120, the cost comparison database is created by using the estimated costs obtained from the actual prices or by the virtual cost estimation at step 110. The estimated costs in the cost comparison database are displayed in the form of a table on a data output screen as shown in FIG. 8. The estimated costs obtained by the virtual cost estimation are displayed with mark ‘*’. Each of the estimated costs is expressed in the currency unit (Japanese Yen, U.S. dollar or the like) of the corresponding operation base at step 120.

At step 130, exchange simulation is performed for the estimated costs in the cost comparison database. Specifically, the estimated costs to be converted are selected and thereafter ‘exchange simulation’ button is selected on the data output screen shown in FIG. 8. As a result, all the selected estimated costs are expressed in the same currency unit (e.g., Japanese Yen). In the exchange simulation, the market rate or the in-company rate with a time limit is employed as an exchange rate.

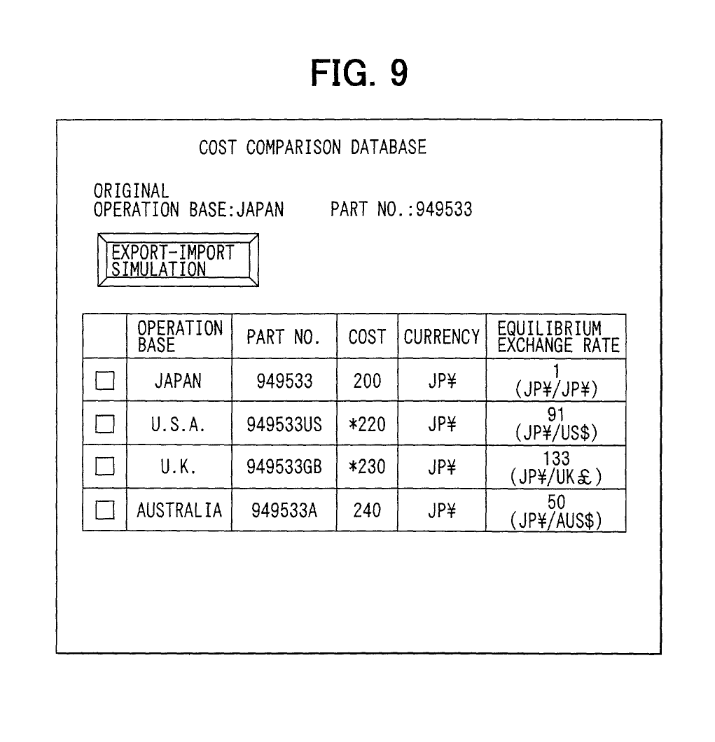

Suppose that exchange rates of yen to the U.S. dollar, the Australian dollar, and the pound are 100 (yen/U.S. dollar), 60 (yen/Australian dollar), and 153 (yen/pound), respectively. By using these exchange rates, the estimated costs are converted so that they are all expressed in Japanese Yen as shown in FIG. 9. For example, the estimated cost corresponding to U.S.A. is 2.2 U.S. dollars and this is converted to 220 yen. As a result of the conversion, the estimated costs become comparable with each other. In the case of this example, the estimated cost corresponding to Japan is the lowest, that is, the article produced at the operation base in Japan is competitive in cost.

Furthermore, at step 140, an equilibrium rate is calculated for each of the estimated costs. The equilibrium rate is an exchange rate at which the estimated cost balances with the reference estimated cost corresponding to original operation base which is the operation base in Japan in this case. For example, the equilibrium rate corresponding to U.S.A. is 91 (yen/U.S. dollar). This means that the estimated cost corresponding to U.S.A. is competitive if the exchange rate is equal to or higher than 91 (yen/U.S. dollar). A decision on whether to provide the article locally or to import the article, is made by comparing the equilibrium rate with the actual exchange rate. In the case of this example, it is determined that the article should be provided locally, if the exchange rate is higher than 91 (yen/U.S. dollar). It is determined that the article should be imported from U.S.A., if the exchange rate is lower than 91 (yen/U.S. dollar).

Further it should not be considered that the article is imported from the foreign operation base, if there is little possibility that the exchange rate become 91 (yen/U.S. dollar) from the point of view of long-term fluctuation of the exchange rate. In this way, based on the equilibrium rate, the decision to provide the article locally or to import the article is readily made in consideration of long-term fluctuation of exchange rate.

The unit costs in the cost comparison database represents the costs of the article which is provided locally at the respective operation base. Therefore export-import simulation is performed at step 150, so that the unit cost including the export-import cost is obtained. Based on the unit cost including the export-import cost, the decision to provide the article locally or to import the article is finally made.

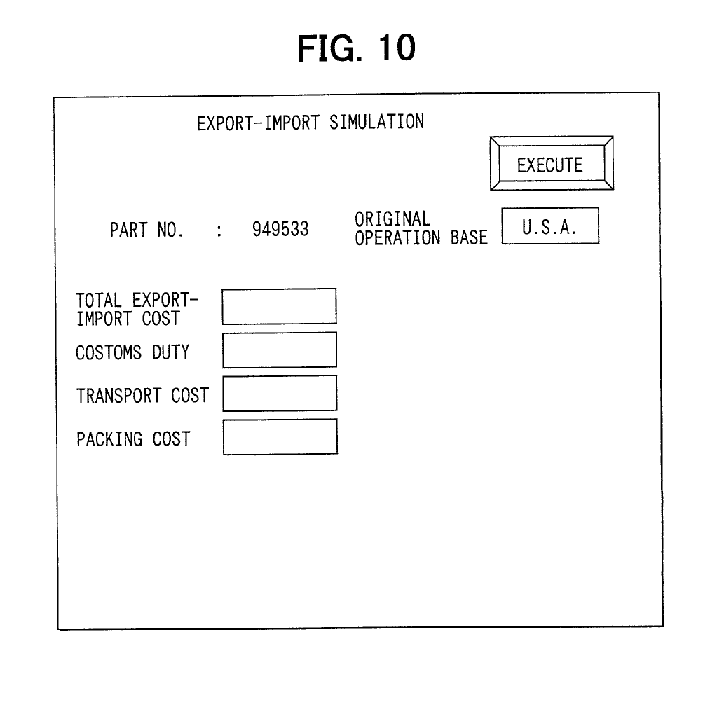

Specifically, the user selects two operation bases, for example, U.S.A. and Japan on the data output screen shown in FIG. 9. If the user further selects ‘export-import simulation’ button, the data input screen for export-import simulation shown in FIG. 10 appears.

First, the user inputs the importing base, for example, U.S.A., which is one of the previously selected two operation bases, and thereafter inputs export-import expenses on the screen. The user further inputs the total export-import cost, for example 40 yen, if it is known. If the total export-import cost is unknown, the user inputs a customs duty, the transport cost, and the packing cost. The transport cost and the packing cost may be calculated from data in the export-import cost table.

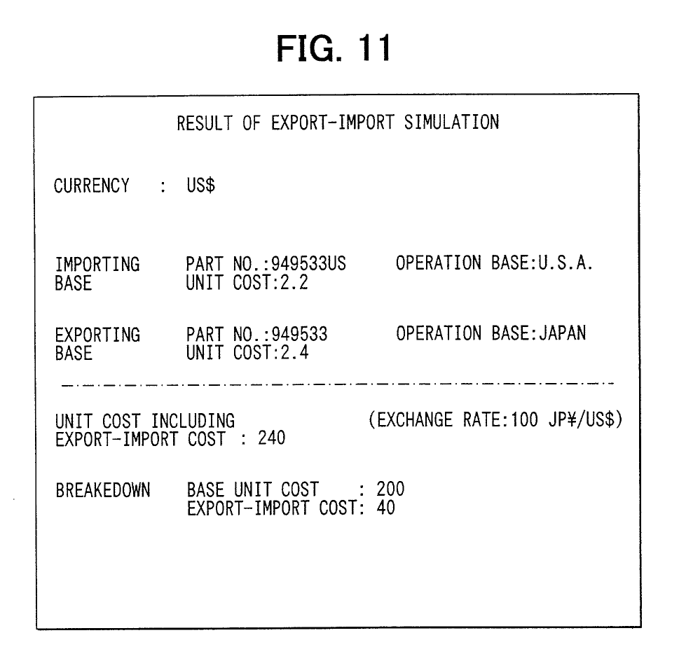

If ‘execute’ button is selected, the export-import simulation is performed and the screen for displaying the result of the export-import simulation shown in FIG. 11 appears. In the case of this example, the unit cost of the article is 2.2 U.S. dollars if the article is provided locally in U.S.A. while the unit cost is 2.4 U.S. dollars if the article is imported from Japan as shown in FIG. 11. In this way, based on the result of the export-import simulation, it is readily determined the operation base from which the article should be imported.

The effects of the cost estimating method of the present embodiment are as follows. The unit costs of the article are provided in the cost comparison database with respect to all the operation bases, that is, the operation bases which actually trade the article and the operation bases which do not actually trade the article. Therefore the user can compare the unit costs globally. Further the user can readily determine the operation base from which the article should be imported based on the equilibrium exchange rate provided as a result of the exchange simulation and the estimated unit cost including the export-import cost provided as a result of the export-import simulation.

Modifications

In the above embodiment, the exchange simulation may be performed after the export-import simulation is performed.

Further in the above embodiment, instead of a country such as Japan or U.S.A, a region such as North America or Southeast Asia which includes a plurality of countries may be employed as the area which includes each of the operation bases.

What is claimed is:

1. A cost estimating method for estimating a cost of an article using an actual price database and a cost table comprising the steps of:
selecting an article subjected to cost estimation and a region subjected to cost estimation of said article;
retrieving, as an estimated cost of said selected article, an actual price of said article from an actual price database, if said article is actually traded in said selected region, said actual price database being created for each possible region subjected to cost estimation beforehand and including actual prices of articles which are actually traded in the corresponding region; and
calculating, as an estimated cost of said selected article, a virtual cost of said article by using factors in a cost table, if said article is not actually traded in said selected region, said cost table being created for each possible region subjected to cost estimation beforehand and including factors necessary for calculating virtual costs of articles which are not actually traded in the corresponding region.

2. A cost estimating method as in claim 1,
wherein said factors in said cost table correspond to regional cost information which differs with regions, and
wherein said virtual cost is calculated by substituting said factors in formulae for cost estimation which are common to all regions.

3. A cost estimating method as in claim 1,
wherein a plurality of regions are selected as said region subjected to cost estimation of said article, and
wherein a cost comparison database is created by using said retrieved actual price corresponding to each of said selected regions in which said article is actually traded and said calculated virtual cost corresponding to each of said selected regions in which said article is not actually traded.

4. A cost estimating method for estimating a cost of an article using an export-import cost table comprising the steps of:
selecting an article subjected to cost estimation and a plurality of regions subjected to cost estimation of said article, said regions including a specific region;
creating a cost comparison database which includes estimated costs of said selected article corresponding to said selected regions;
selecting an importing region and an exporting region from said selected regions;
retrieving an estimated cost corresponding to said exporting region from said cost comparison database;
retrieving, from an export-import cost table, expenses for trading said selected article from said exporting region to said importing region, said export-import cost table being created beforehand and including expenses for trading articles between possible regions subjected to cost estimation;
calculating an estimated cost including export-import cost by using said retrieved estimated cost corresponding to said exporting region and said retrieved expenses;
selecting at least one region from said selected region;
retrieving estimated costs corresponding to said selected region and said specific region from said cost comparison database; and
calculating an equilibrium exchange rate at which said retrieved estimated cost corresponding to said selected region balances said retrieved estimated cost corresponding to said specific region.

5. A cost estimating method for estimating a cost of an article comprising the steps of:
selecting an article subjected to cost estimation and a plurality of regions subjected to cost estimation of said article, said regions including a specific region;
creating a cost comparison database which includes estimated costs of said selected article corresponding to said selected regions;
selecting at least one region from said selected regions;
retrieving estimated costs corresponding to said selected region and said specific region from said cost comparison database; and
calculating an equilibrium exchange rate at which said retrieved estimated cost corresponding to said selected region balances said retrieved estimated cost corresponding to said specific region.

6. A cost estimating apparatus for estimating a cost of an article using an actual price database and a cost table comprising:
subject selecting means for selecting an article subjected to cost estimation and a region subjected to cost estimation of said article; and
cost estimating means for retrieving, as an estimated cost of said selected article, an actual price of said article from an actual price database if said article is actually traded in said selected region, and calculating, as an estimated cost of said selected article, a virtual cost of said article by using data in a cost table if said article is not actually traded in said selected region,
wherein said actual price database is created for each possible region subjected to cost estimation beforehand, and includes actual prices of articles which are actually traded in the corresponding region, and
wherein said cost table is created for each possible region subjected to cost estimation beforehand, and includes factors necessary for calculating virtual costs of articles which are not actually traded in the corresponding region.

7. A cost estimating apparatus as in claim 6,
wherein said factors in said cost table correspond to regional cost information which differs with regions, and
wherein said virtual cost is calculated by substituting said factors in formulae for cost estimation which are common to all regions.

8. A cost estimating apparatus as in claim 6,
wherein a plurality of regions are selected as said region subjected to cost estimation of said article, and
wherein a cost comparison database is created by using said actual price corresponding to each of said selected regions in which said article is actually traded and said virtual cost corresponding to each of said selected regions in which said article is not actually traded.

9. A cost estimating apparatus for estimating a cost of an article using an export-import cost table comprising:
a cost comparison database which includes estimated costs of an article corresponding to a plurality of regions including a specific region;
first selecting means for selecting an importing region and an exporting region from said regions;
first retrieving means for retrieving said estimated cost corresponding to said exporting region from said cost comparison database;
second retrieving means for retrieving, from an export-import cost table, expenses for trading said article from said exporting region to said importing region, said export-import cost table being created beforehand and including expenses for trading articles between regions;
cost calculating means for calculating an estimated cost including export-import cost by using said retrieved estimated cost corresponding to said exporting region and said retrieved expenses;
second selecting means for selecting at least one region from said regions;
third retrieving means for retrieving estimated costs corresponding to said selected region and said specific region; and
rate calculating means for calculating an equilibrium exchange rate at which said retrieved estimated cost corresponding to said selected region balances said retrieved estimated cost corresponding to said specific region.

10. A cost estimating apparatus for estimating a cost of an article comprising:
first selecting means for selecting an article subjected to cost estimation and a plurality of regions subjected to cost estimation of said article, said regions including a specific region;
database creating means for creating a cost comparison database which includes estimated costs of said selected article corresponding to said selected regions;
second selecting means for selecting at least one region from said selected regions;
cost retrieving means for retrieving estimated costs corresponding to said selected region and said specific region from said cost comparison database; and
rate calculating means for calculating an equilibrium exchange rate at which said retrieved estimated cost corresponding to said selected region balances said retrieved estimated cost corresponding to said specific region.

11. A computer program product including a computer readable medium, said computer readable medium having a cost estimating computer program stored thereon, said cost estimating program for execution in a computer and comprising:
program code for selecting an article subjected to cost estimation and a region subjected to cost estimation of said article;
program code for retrieving, as an estimated cost of said selected article, an actual price of said article from an actual price database if said article is actually traded in said selected region, said actual price database being created for each possible region subjected to cost estimation beforehand and including actual prices of articles which are actually traded in the corresponding region; and
program code for calculating, as an estimated cost of said selected article, a virtual cost of said article by using factors in a cost table if said article is not actually traded in said selected region, said cost table being created for each possible region subjected to cost estimation beforehand and including factors necessary for calculating virtual costs of articles which are not actually traded in the corresponding region.

12. A computer program product as in claim 11,
wherein said factors in said cost table correspond to regional cost information which differs with regions, and
wherein said virtual cost is calculated by substituting said factors in formulae for cost estimation which are common to all regions.

13. A computer program product as in claim 11,
wherein a plurality of regions are selected as said region subjected to cost estimation of said article, and
wherein a cost comparison database is created by using said actual price corresponding to each of said selected regions in which said article is actually traded and said virtual cost corresponding to each of said selected regions in which said article is not actually traded.

14. A computer program product including a computer readable medium, said computer readable medium having a cost estimating computer program stored thereon, said cost estimating program for execution in a computer and comprising:
program code for selecting an article subjected to cost estimation and a plurality of regions subjected to cost estimation of said article, said regions including a specific region;
program code for creating a cost comparison database which includes estimated costs of said selected article corresponding to said selected regions;
program code for selecting an importing region and an exporting region from said selected regions;
program code for retrieving an estimated cost corresponding to said exporting region from said cost comparison database;
program code for retrieving, from an export-import cost table, expenses for trading said selected article from said exporting region to said importing region, said export-import cost table being created beforehand and including expenses for trading articles between possible regions subjected to cost estimation;
program code for calculating an estimated cost including export-import cost by using said retrieved estimated cost corresponding to said exporting region and said retrieved expenses;
program code for selecting at least one region from said selected regions;
program code for retrieving estimated costs corresponding to said selected region and said specific region; and
program code for calculating an equilibrium exchange rate at which said retrieved estimated cost corresponding to said selected region balances said retrieved estimated cost corresponding to said specific region.

15. A computer program product including a computer readable medium, said computer readable medium having a cost estimating computer program stored thereon, said cost estimating program for execution in a computer and comprising:
program code for selecting an article subjected to cost estimation and a plurality of regions subjected to cost estimation of said article, said regions including a specific region;
program code for creating a cost comparison database which includes estimated costs of said selected article corresponding to said selected regions;
program code for selecting at least one region from said selected regions;
program code for retrieving estimated costs corresponding to said selected region and said specific region from said cost comparison database; and
program code for calculating an equilibrium exchange rate at which said retrieved estimated cost corresponding to said selected region balances said retrieved estimated cost corresponding to said specific region.

16. A cost estimating system for estimating a cost of an article comprising:
a central processing unit (CPU);
input hardware means coupled to said CPU;
output hardware means coupled to said CPU;
first memory means coupled to said CPU, said first memory means including an actual price database, a cost table, and an export-import cost table, said actual price database including actual prices of articles which are actually traded, said cost table including factors necessary for estimating costs of articles which are not actually traded, said export-import cost table including expenses for trading articles between regions; and
second memory means coupled to said CPU, said second memory means including software means executed by said central processing unit, said software means comprising:
program code for receiving, through said input hardware means, data input which designates an article subjected to cost estimation and a plurality of regions subjected to cost estimation of said article, the said regions including a specific region;
program code for estimating costs of said article with regard to said respective regions in which said article is actually traded by using data in said actual price database and estimating costs of said article with regard to said respective regions in which said article is not actually traded by using data in said cost table;
program code for creating a cost comparison database which includes said estimated costs and displaying data in said cost comparison database on said output hardware means;
program code for receiving, through said input hardware means, data input which designates at least one region selected from said regions;
program code for retrieving said estimated costs corresponding to said specific region and said selected region from said cost comparison database;
program code for calculating an equilibrium exchange rate at which said retrieved estimated cost corresponding to said selected region balances said retrieved estimated cost corresponding to said specific region and displaying said equilibrium exchange rate on said output hardware means;
program code for receiving, through said input hardware means, data input which designates an importing region and an exporting region selected from said regions;
program code for retrieving estimated cost corresponding to said exporting regions from said cost comparison database, and expenses for trading said article from said exporting region to said importing region from said export-import cost table; and
program code for calculating an estimated cost including export-import cost by using said retrieved estimated cost corresponding to said exporting region and said retrieved expenses and displaying said estimated cost including export-import cost on said output hardware means.

17. A cost estimating system as in claim 16,
wherein said first memory means includes a local memory and a plurality of remote memories which are placed at a plurality of operation bases in various regions in the world, and each of said memories stores said actual price database, said regional cost table, and said export-import cost table which include data concerning the corresponding region, and wherein said central processing unit is connected to said remote memories through a communication network.
